(19) United States
(12) Patent Application Publication
(10) Pub. No.: US 2025/0253304 A1
(43) Pub. Date: Aug. 7, 2025

(54) REVERSE LAMINATION METHOD FOR BATTERY SLURRY COATING

(71) Applicant: GM GLOBAL TECHNOLOGY OPERATIONS LLC, Detroit, MI (US)

(72) Inventors: Ming Wang, Sterling Heights, MI (US); Robin James, Rochester Hills, MI (US); Xiaowei Yu, Farmington Hills, MI (US); Wayne Cai, Troy, MI (US); Ryan Curtis Sekol, Grosse Pointe Woods, MI (US); Erik Damon Huemiller, Troy, MI (US); Changbai Tan, Ann Arbor, MI (US); Jennifer Therese Bracey, Holly, MI (US)

(21) Appl. No.: 18/429,597

(22) Filed: Feb. 1, 2024

(51) Int. Cl. H01M 4/04; H01M 4/62

(52) U.S. Cl. CPC H01M 4/0404; H01M 4/0435; H01M 4/0471; H01M 4/621

(57) ABSTRACT

A method for forming an electrode, the method including: applying an active layer on a transfer device configured to move the active layer onto a current collector, the active layer including at least one binder, at least one active material, and at least one solvent; heating the active layer to evaporate the at least one solvent and draw the at least one binder to an outer surface of the active layer; and after heating the active layer, applying the active layer to the current collector with the outer surface in contact with the current collector.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to methods and systems for coating electrodes with an active layer.

Electric vehicles (EVs), such as battery electric vehicles (BEVs), hybrid vehicles, and/or fuel cell vehicles, include one or more electric machines and a battery system including one or more battery cells, modules, and/or packs. Each battery includes electrodes with current collectors coated with active material. A power control system is used to control charging and/or discharging of the battery system during charging and/or driving.

### SUMMARY

The present disclosure includes, in various features, a method for forming an electrode. The method includes the following: applying an active layer on a transfer device configured to move the active layer onto a current collector, the active layer including at least one binder, at least one active material, and at least one solvent; heating the active layer to evaporate the at least one solvent and draw the at least one binder to an outer surface of the active layer; and after heating the active layer, applying the active layer to the current collector with the outer surface in contact with the current collector.

In further features, the present disclosure includes drying the active layer with a dryer after the active layer is applied to the current collector.

In further features, heating the active layer to evaporate the at least one solvent includes heating the transfer device, which transfers heat to the active layer.

In further features, the present disclosure includes heating the active layer with a heater adjacent to the transfer device.

In further features, the present disclosure includes heating the active layer present on the transfer device by circulating a heating fluid through the transfer device.

In further features, the present disclosure includes heating the active layer present on the transfer device with heat generated by induction coils.

In further features, the present disclosure includes heating the active layer present on the transfer device with heat generated by an electrically conductive cover on the transfer device.

In further features, the present disclosure includes applying the active layer on the transfer device includes applying the active layer to a conveyor belt seated on a roller of the transfer device.

In further features, the present disclosure includes heating the active layer with a heater adjacent to the conveyor belt.

In further features, the present disclosure includes, after heating the active layer to evaporate the at least one solvent and draw the at least one binder to an outer surface of the active layer, applying the active layer to both a first side and a second side of the current collector with the outer surface in contact with the current collector, the first side is opposite to the second side.

The present disclosure also includes, in various features, a system for applying an active layer to a current collector to form an electrode. The system includes the following: a transfer device configured to move the active layer onto the current collector; a coater configured to apply the active layer to the transfer device with the active layer including at least one binder, at least one solvent, and at least one active material; a heater configured to heat the active layer prior to application of the active layer onto the current collector to evaporate the at least one solvent and draw the at least one binder to an outer surface of the active layer.

In further features, subsequent to the active layer being heated by the heater, the transfer device is configured to move the active layer onto the current collector with the outer surface in contact with the current collector; and the system further includes a dryer configured to heat the active layer subsequent to application of the active layer onto the current collector.

In further features, the transfer device includes a roller.

In further features, the heater is included with the transfer device.

In further features, the heater includes apertures defined within the transfer device configured to receive a heated liquid.

In further features, the heater includes a conductive layer on an external surface of the transfer device.

In further features, the transfer device is a first roller, the system further including a second roller opposite to the first roller, the second roller configured to apply pressure to add an additional active layer onto the current collector.

The present disclosure also provides for, in various features, a system for applying an active layer to a current collector to form an electrode. The system includes: a conveyor belt configured to move the active layer onto the current collector; conveyor rollers configured to drive the conveyor belt; a coater configured to apply the active layer to the conveyor belt with the active layer in the form of a slurry including at least one binder and at least one solvent, at least one active material, and at least one conductive additive; and a heater configured to heat the active layer prior to application of the active layer onto the current collector to evaporate the at least one the solvent and draw the at least one binder to an outer surface of the active layer. Subsequent to the active layer being heated by the heater, the conveyor belt is configured to move the active layer onto the current collector with the outer surface in contact with the current collector.

In further features, the heater is adjacent to the conveyor belt to heat the active layer prior to deposition of the active layer on the current collector.

In further features, the heater is included with the conveyor rollers.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side, cross-sectional view of an exemplary battery cell including current collectors coated with active layers in accordance with the present disclosure;

FIG. 2 is a perspective view of an example of a prismatic battery cell including current collectors coated with active layers in accordance with the present disclosure;

FIG. 3 is a perspective view of another example of a prismatic battery cell including current collectors coated with active layers in accordance with the present disclosure;

FIGS. 4A and 4B illustrate an exemplary system for applying an active layer to a current collector in accordance with the present disclosure;

FIG. 5 illustrates another system in accordance with the present disclosure for applying an active layer to a current collector;

FIG. 6 illustrates an additional system in accordance with the present disclosure for applying an active layer to a current collector;

FIG. 7 illustrates yet another system in accordance with the present disclosure for applying an active layer to a current collector; and

FIG. 8 illustrates an exemplary method in accordance with the present disclosure for applying an active layer to a current collector.

In the drawings, reference numbers may be reused to identify similar and/or identical elements.

### DETAILED DESCRIPTION

The present disclosure provides various methods for coating a battery current collector with an active layer to form an electrode. The active layer includes one or more active materials, at least one conductive additive, and at least one binder. The binder holds the active material and the conductive additive together, which provides mechanical stability to the electrode. The binder also binds the active layer to the current collector. In slurry-based electrode manufacturing, the binder transitions from a liquid or gel-like state to a solid state as at least one solvent evaporates during the drying process. During this phase transition, the binder may be driven by capillary forces to migrate to an outer surface of the electrode coating. The capillary forces pull the binder towards the outer surface of the coating, which traditionally resulted in regions at an inner surface of the coating at the coating/current collector interface having relatively low binder content. Excessive binder migration may lead to uneven distribution of the binder, which may affect adhesion strength between the electrode/current collector interface and may affect mechanical properties of the electrode. The slurry can also be made without separately mixing binder solutions. For example, a slurry can be mixed straight away without mixing the binder solution first (this is commonly done on pilot line and larger scales). Also, the slurry can contain zero conductive additives, one conductive additive, or combinations of conductive additives. Non-conductive additives can also be included, such as dispersants and/or viscosity modifiers.

With respect to the present disclosure, the active layer slurry is first coated on any suitable transfer device, such as a roller or conveyor belt, for example, at an elevated temperature, instead of being coated directly on the current collector. During this application step, at least one binder migrates from the coating/roller interface to an outer surface of the coating, which creates a binder-rich surface. The coating is then laminated on the current collector in “reverse:” the binder-rich top surface of the coating, which was facing outwards (or upwards), becomes the bottom layer at the interface between the coating and the current collector. This application method may decrease both drying duration and space required for drying. Furthermore, the method may enhance adhesion strength thereby allowing relatively thicker electrodes to be formed. Still further, because the binder is not electrically conductive, moving the binder closer to the current collector will minimize the non-conductive effect of the binder because the non-conductive nature of the binder will be countered by the conductive current collector.

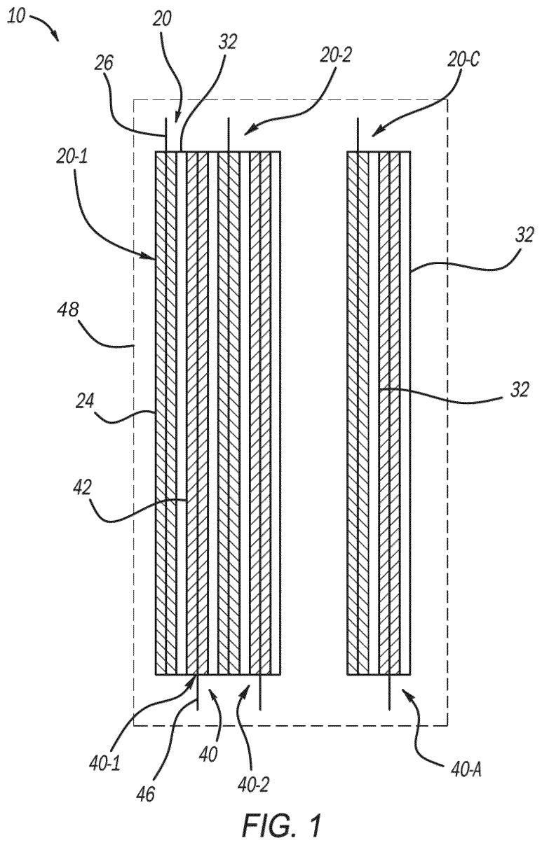

Referring now to FIG. 1, a battery cell 10 in accordance with the present disclosure is illustrated. The battery cell 10 may be configured for use in any suitable application, such as any suitable automotive or non-automotive application. The battery cell 10 includes C cathode electrodes 20, A anode electrodes 40, and S separators 32 arranged in a predetermined sequence in a stack 12, which is seated in an enclosure 48. C, A, and S are integers, which are each greater than one. In some examples, A=C+1. The C cathode electrodes 20-1, 20-2, . . . , and 20-C include cathode active layers 24 arranged on one or both sides of cathode current collectors 26. The A anode electrodes 40-1, 40-2, . . . , and 40-A include anode active layers 42 arranged on one or both sides of the anode current collectors 46.

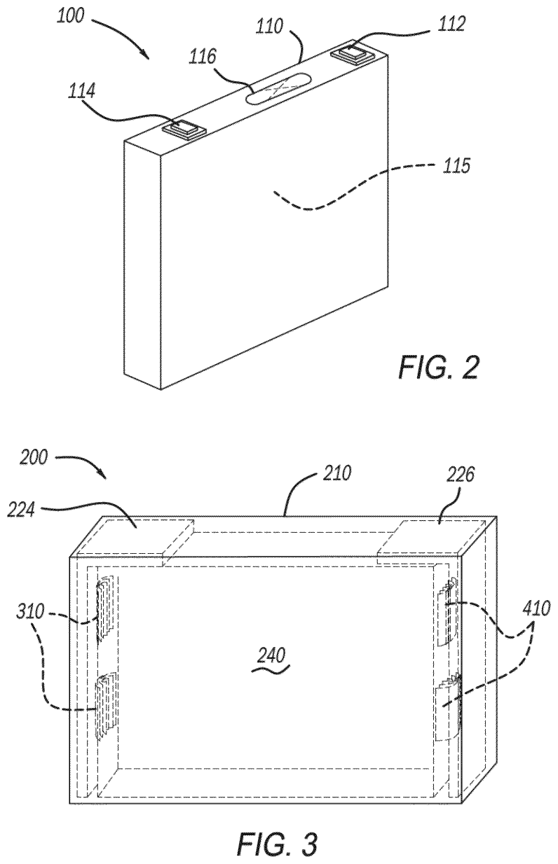

Referring now to FIG. 2, a prismatic battery cell 100 includes an enclosure 110. In some examples, the enclosure 110 has a rectangular cross-section. The prismatic battery cell 100 includes external terminals 112 and 114, and a vent cap 116. A stack 115 of the C cathode electrodes 20, the A anode electrodes 40, and the S separators 32 is arranged in the enclosure 110. The anode current collectors 46 and/or the cathode current collectors 26 include external tabs that are laser welded to internal terminals contacting the external terminals 112 and 114 of the battery cell 10.

With reference to FIG. 3, a prismatic battery cell 200 includes an enclosure 210 and internal terminals 224 and 226 arranged at opposite ends of the enclosure 210. A stack 240 of the C cathode electrodes, the A anode electrodes, and the S separators is arranged in the enclosure 210. The cathode current collectors and/or the anode current collectors include external connector tabs 310 and 410 that extend therefrom, respectively. The external connector tabs 310 and 410 are laser welded to inner surfaces of the internal terminals 224 and 226 respectively, as further described herein.

In some examples, the cathode active layers 24 and/or the anode active layers 42 comprise coatings including one or more active materials, one or more conductive fillers/additives, and/or one or more binder materials. Exemplary active materials for the cathode include, but are not limited to, lithium nickel manganese cobalt oxide (LiNiₓMn_{y}Co_{1-x-y}O₂), lithium cobalt oxide (LiCoO₂), lithium manganese oxide (LiMn₂O₄), lithium iron phosphate (LiFePO₄). Graphite is an exemplary anode active material. Exemplary conductive materials include, but are not limited to, carbon black, graphite, carbon nanotubes, graphene, conductive polymers such as polyaniline or polypyrrole, aluminum, copper, and carbon nanofibers. Exemplary binders include, but are not limited to, polyvinylidene fluoride (PVDF), polyacrylic acid (PAA), carboxymethyl cellulose (CMC), styrene-butadiene rubber (SBR), polyethylene oxide (PEO), Polyvinyl alcohol (PVA).

At least one binder is dissolved into at least one solvent to form a binder solution. The binder solution is mixed with the active materials and conductive additives to form a slurry. The slurry is coated onto the current collectors 26, 46 in a roll-to-roll manufacturing process, as described herein. In some examples the cathode current collectors 26 and/or the anode current collectors 46 comprise a foil layer, which may include perforated foil or mesh. In some examples, the current collectors are made of copper, stainless steel, brass, bronze, zinc, aluminum, and/or alloys thereof. The current collectors 26 may also be made of any other material that is electrochemically stable within the operating voltage range of the electrode 20-1, 40-1. In some examples, external tabs connected to the current collectors of the anode electrodes and cathode electrodes are located on opposite sides of the battery stack or on the same side of the battery stack as shown below.

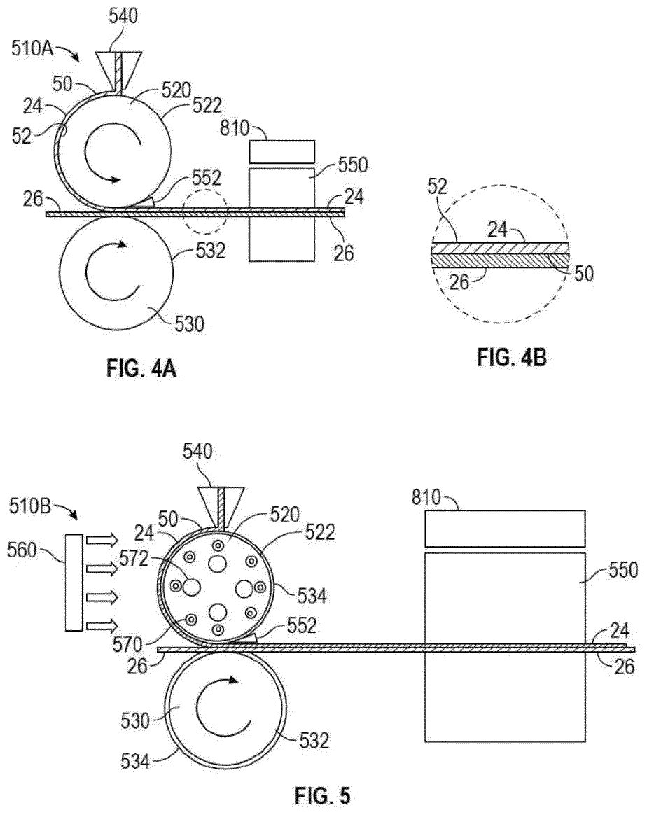

FIGS. 4A-7 illustrate various systems in accordance with the present disclosure for applying the active layers to the electrodes. Although FIGS. 4A-7 illustrate systems for applying the cathode active layer 24 to the cathode current collector 26, the systems of the present disclosure are configured to apply the anode active layer 42 to the anode current collector 46 in the same manner.

With particular reference to FIGS. 4A and 4B, a system 510A in accordance with the present disclosure includes a first roller 520 and a second roller 530 opposite to the first roller 520. The first roller 520 includes an outer surface 522, and the second roller 530 includes an outer surface 532. The cathode current collector 26 is in contact with the outer surface 532 of the second roller 530, and the second roller 530 is configured to rotate to move the cathode current collector 26 within the system 510A. The first roller 520 and the second roller 530 may be replaced with any other suitable transfer devices, such as a conveyor, a moving web, etc.

The system 510A further includes a coater 540 configured to apply the cathode active layer 24 onto the outer surface 522 of the first roller 520. The coater 540 may be any suitable coating device, such as a slot-die coater. The cathode active layer 24 may be applied in any other suitable manner as well, such as with any suitable reverse comma coating system so long as ultimately an outer surface 50 of the active layer 24 is applied to the current collector 26.

As applied to the outer surface 522, the active layer 24 includes the outer surface 50 and an inner surface 52, which is opposite to the outer surface 50. The inner surface 52 of the active layer 24 contacts the outer surface 522 of the first roller 520. Thus, the outer surface 50 of the active layer 24 is on a side of the active layer 24 opposite to the first roller 520. The first roller 520 is configured to rotate and apply the active layer 24 onto the current collector 26 between the first roller 520 and the second roller 530. Adjacent to the first roller 520 is a blade scraper 552, which is configured to facilitate separation of the active layer 24 from the current collector 26. The first roller 520 may also be coated with any suitable non-stick coating to facilitate removal of the active layer 24.

The active layer 24 is applied onto the outer surface 522 of the first roller 520 as a wet slurry. The system 510A heats the active layer 24 in any suitable manner to evaporate the solvent from the slurry prior to transferring the active layer 24 onto the current collector 26. During the evaporation, capillary forces cause the binder to migrate from the inner surface 52 of the active layer 24 to the outer surface 50. As a result, the outer surface 50 becomes a binder-rich surface. Further rotation of the first roller 520 applies the active layer 24 to the current collector 26 such that the binder-rich outer surface 50 directly contacts the current collector 26. Thus, the binder-rich outer surface 50, which was originally facing outward on the first roller 520, becomes a bottom layer at an interface between the active layer 24 and the current collector 26 to bind the active layer 24 to the current collector 26. The current collector 26 with the active layer 24 thereon is then transferred to the dryer 550, which further dries the active layer 24 to eliminate any remaining solvent. The dryer 550 may be any suitable dryer, such as a drying furnace.

As referenced above, the active layer 24 in slurry form is heated prior to being applied onto the current collector 26. The active layer 24 may be heated in any suitable manner. For example, and as illustrated in the exemplary system 510B of FIG. 5, the first roller 520 may include induction coils 570 configured to be connected to any suitable current source. Electrical current applied to the induction coils 570 heats the coils 570, which heat the first roller 520 and the active layer 24 applied thereto. The induction coils 570 may be configured to heat the first roller 520 by electro-magnetic induction. For example, the induction coils 570 may be evenly installed about an inside of the first roller 520. Alternating currents will be charged, then a line of magnetic force will be generated and the eddy current induced by this line of magnetic force will flow on the outer surface 522 of the first roller 520 to heat the active layer 24. Thermal pipes 572 may be located around the induction coils 570 to remove excess heat generated by the induction coils 570 to provide temperature control. The induction coils 570 may be within the first roller 520 or adjacent thereto.

The thermal pipes 572 may alternatively be included independent of the induction coils 570 and configured to receive any suitable material suitable for being heated. For example, any suitable heating fluid may be included, such as, but not limited to, hot oil, water, steam, etc. may be circulated through the thermal pipes 572 to heat the first roller 520, which in turn heats the active layer 24 applied to the first roller 520. Still further, the first roller 520 may be coated with any suitable conductive material 534 and connected to any suitable current source such that upon running current through the conductive material 534 the temperature of the conductive material increases, which heats the active layer 24 applied thereon. The first roller 520 may include one or more of the induction coils 570, the thermal pipes 572, and the conductive material 534.

The active layer 24 may also be heated by any suitable external heat source prior to being applied onto the current collector 26. For example and as illustrated in FIG. 5, a heater 560 may be included and positioned adjacent to the first roller 520 to heat the active layer 24 prior to the active layer 24 being deposited onto the current collector 26. The heater 560 may be any suitable heat source. For example, the heater 560 may be an induction heater, a microwave waveguide heater, a heat flow generator, an infrared radiation (IR/NIR) heater, laser induced drying, etc.

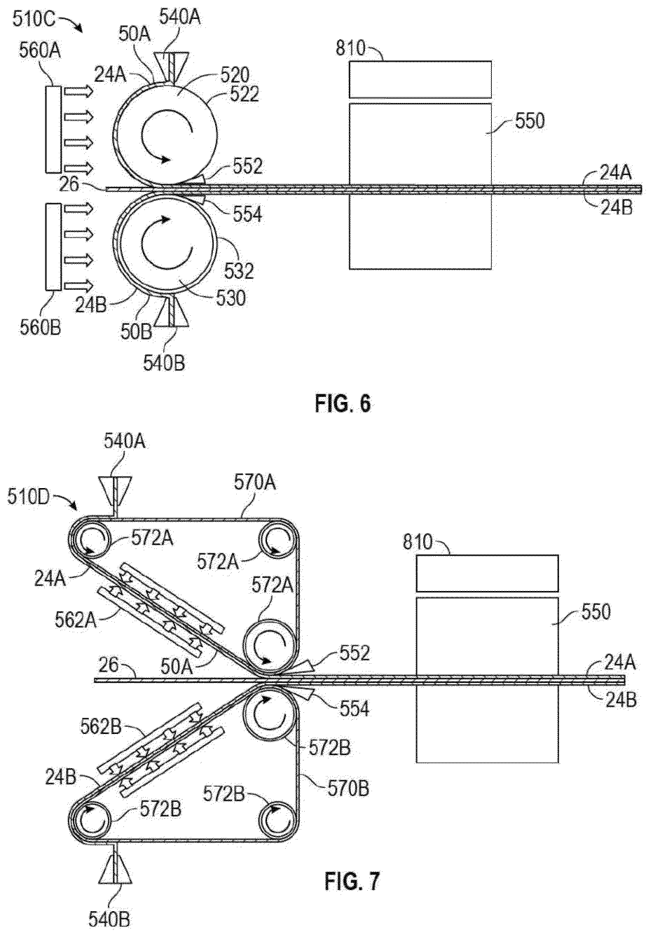

FIG. 6 illustrates an additional system 510C in accordance with the present disclosure. The system 510C is configured to apply a first active layer 24A to a first side of the current collector 26 and a second active layer 24B to a second side of the current collector 26. The second active layer 24B may be the same as, or substantially the same as, the first active layer 24A. For the system 510C, the coater is a first coating device 540A and a second coating device 540B is adjacent to the second roller 530. The second coating device 540B may be the same as, or substantially similar to, the first coating device 540A. The second coating device 540B applies the second active layer 24B to the second side of the current collector 26 in the same manner described above with respect to the first coating device 540A. The second active layer 24B is heated prior to being deposited onto the current collector 26 in the same manner described above with respect to heating the first active layer 24A. In addition to a first heater 560A for the first active layer 24A, a second heater 560B may be included to heat the second active layer 24B prior to being deposited onto the current collector 26.

FIG. 7 illustrates an additional system 510D in accordance with the present disclosure for heating the first active layer 24A and the second active layer 24B. The system 510D includes a first conveyor belt 570A, which extends around and is rotated by first conveyor rollers 572A, and a second conveyor belt 570B, which extends around and is rotated by second conveyor rollers 572B. The first coating device 540A applies the first active layer 24A to the first conveyor belt 570A. The second coating device 540B applies the second active layer 24B to the second conveyor belt 570B. The first conveyor belt 570A with the first active layer 24A thereon is directed past a first heater 562A to heat the first active layer 24A prior to being deposited onto the current collector 26. The second conveyor belt 570B with the second active layer 24B thereon is directed past a second heater 562B to heat the second active layer 24B prior to being deposited onto the current collector 26. In addition to the first and second heaters 562A, 562B, the first conveyor roller 572A directly upstream of the first heater 562A, and the second conveyor roller 572B directly upstream of the second heater 562B, may be heated in any suitable manner as described above with respect to the first and second rollers 520, 530. Although the system 510D illustrates both sides of the current collector 26 being coated with the first and second active layers 24A, 24B, the system 510D may be configured to only coat one side of the current collector 26 with the first active layer 24A or the second active layer 24B.

The present disclosure further provides for various binder activations and surface treatments of the current collector 26 to facilitate adhesion of the active layers 24, 24A, 24B to the current collector 26. For example, the adhesion may be provided by a primer coating applied to the outer surfaces 522, 532 of the first roller 520 and/or the second roller 530. Any suitable conductive polymer primer may be included to increase the adhesion and reduce interfacial conductivity. Suitable conductive polymers include, but are not limited to, the following: a conductive polyvinylidene fluoride; polyethylene; carboxymethyl cellulose; and styrene butadiene rubber. The primer may be applied as either a wet coating for direct lamination or a dry coating that is activated through hot rolling to achieve adhesion. The dry coating may be thermally activated using the laminating rollers 520, 530 or another set of hot rollers. The adhesion may also be achieved by applying any suitable solvent by spraying the solvent onto the current collector 26 prior to application of the active layer 24, 24A, 24B. Suitable solvents include, but are not limited to, the following: N-methyl-2-pyrrolidone, dimethyl sulfoxide; gamma-valerolactone; and deionized water.

Prior to applying the active layers 24, 24A, 24B to the current collector 26, the current collector 26 may be treated to remove contaminants in any suitable manner. For example, the current collector 26 may be subject to any suitable plasma treatment, such as an oxygen or air plasma treatment. Such treatments also etch the surface of the current collector 26 to increase the roughness thereof and facilitate cooperation between the current collector 26 and the active layers 24, 24A, 24B.

To further facilitate cooperation between the current collector 26 and the active layers 24, 24A, 24B, pressure may be applied by one or more of the rollers 520, 530, 572A, 572B to press the active layers 24, 24A, 24B onto the current collectors 26, thereby enhancing interfacial contact of the active layers 24, 24A, 24B with the current collector 26 and reducing the volume of the active layers 24, 24A, 24B.

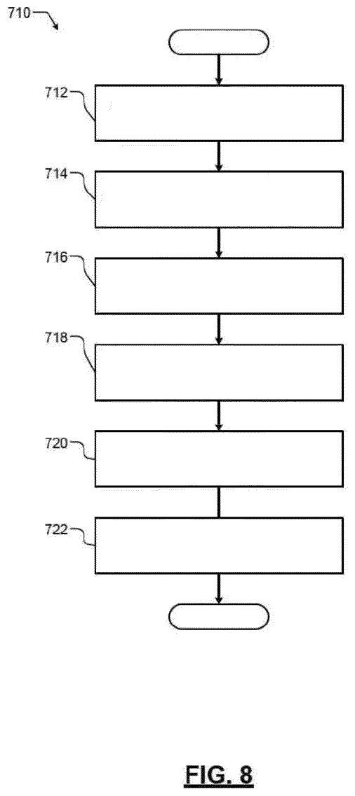

FIG. 8 illustrates an exemplary method 710 in accordance with the present disclosure for applying the active layer 24 (including the first active layer 24A and the second active layer 24B) onto the current collector 26. The method 710 may be performed by any of the systems 510A, 510B, 510C, 510D of the present disclosure, or any other suitable systems. Operation of the method 710 and the systems 510A, 510B, 510C, 510D may be carried out by, or otherwise coordinated by, any suitable controller 810. At block 712, the method 710 includes dissolving the binder into a solvent to form the electrode binder solution. At block 714, the binder solution is mixed with the active materials and the conductive additive to form the active layer 24, 24A, 24B in slurry form. At block 716, the active layer 24, 24A, 24B in slurry form is applied onto the rollers 520, 530 or the conveyor belts 570A, 570B. At block 718, the active layer 24, 24A, 24B slurry is heated in any suitable manner, as described above, prior to being applied to the current collector 26. For example, the active layer 24, 24A, 24B may be heated by heating the rollers 520, 530, 572A, 572B or by using heaters 560, 560A, 560B, 562A, 562B. Heating the active layer 24, 24A, 24B evaporates the solvent and draws the binder to the outer surface 50 of the active layer 24, 24A, 24B, as explained above. At block 720, the active layer 24, 24A, 24B is applied to the current collector 26 with the outer surface 50 in contact with the current collector 26. The outer surface 50 is a binder-rich surface that facilitates binding of the active layer 24, 24A, 24B onto the current collector 26. At block 722, the applied active layer 24, 24A, 24B is dried further, such as by the drier 550, to evaporate any remaining solvent.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for forming an electrode, the method comprising:
applying an active layer on a transfer device configured to move the active layer onto a current collector, the active layer including at least one binder, at least one active material, and at least one solvent;
heating the active layer to evaporate the at least one solvent and draw the at least one binder to an outer surface of the active layer; and
after heating the active layer, applying the active layer to the current collector with the outer surface in contact with the current collector.

2. The method of claim 1, further comprising drying the active layer with a dryer after the active layer is applied to the current collector.

3. The method of claim 1, wherein heating the active layer to evaporate the at least one solvent includes heating the transfer device, which transfers heat to the active layer.

4. The method of claim 1, further comprising heating the active layer with a heater adjacent to the transfer device.

5. The method of claim 1, further comprising heating the active layer present on the transfer device by circulating a heating fluid through the transfer device.

6. The method claim 1, further comprising heating the active layer present on the transfer device with heat generated by induction coils.

7. The method of claim 1, further comprising heating the active layer present on the transfer device with heat generated by an electrically conductive cover on the transfer device.

8. The method of claim 1, wherein applying the active layer on the transfer device includes applying the active layer to a conveyor belt seated on a roller of the transfer device.

9. The method of claim 8, further comprising heating the active layer with a heater adjacent to the conveyor belt.

10. The method of claim 1, further comprising, after heating the active layer to evaporate the at least one solvent and draw the at least one binder to an outer surface of the active layer, applying the active layer to both a first side and a second side of the current collector with the outer surface in contact with the current collector, the first side is opposite to the second side.

11. A system for applying an active layer to a current collector to form an electrode, the system comprising:
a transfer device configured to move the active layer onto the current collector;
a coater configured to apply the active layer to the transfer device with the active layer including at least one binder, at least one solvent, and at least one active material; and
a heater configured to heat the active layer prior to application of the active layer onto the current collector to evaporate the at least one solvent and draw the at least one binder to an outer surface of the active layer.

12. The system of claim 11, wherein subsequent to the active layer being heated by the heater, the transfer device is configured to move the active layer onto the current collector with the outer surface in contact with the current collector; and
the system further includes a dryer configured to heat the active layer subsequent to application of the active layer onto the current collector.

13. The system of claim 11, wherein the transfer device includes a roller.

14. The system of claim 11, wherein the heater is included with the transfer device.

15. The system of claim 14, wherein the heater includes apertures defined within the transfer device configured to receive a heated liquid.

16. The system of claim 14, wherein the heater includes a conductive layer on an external surface of the transfer device.

17. The system of claim 11, wherein the transfer device is a first roller, the system further including a second roller opposite to the first roller, the second roller configured to apply pressure to add an additional active layer onto the current collector.

18. A system for applying an active layer to a current collector to form an electrode, the system comprising:
a conveyor belt configured to move the active layer onto the current collector;
conveyor rollers configured to drive the conveyor belt;
a coater configured to apply the active layer to the conveyor belt, the active layer including at least one binder, at least one solvent, at least one active material, and at least one conductive additive; and
a heater configured to heat the active layer prior to application of the active layer onto the current collector to evaporate the at least one solvent and draw the at least one binder to an outer surface of the active layer,
wherein subsequent to the active layer being heated by the heater the conveyor belt is configured to move the active layer onto the current collector with the outer surface in contact with the current collector.

19. The system of claim 18, wherein the heater is adjacent to the conveyor belt to heat the active layer prior to deposition of the active layer on the current collector.

20. The system of claim 18, wherein the heater is included with the conveyor rollers.
